(19) United States
(12) Patent Application Publication
(10) Pub. No.: US 2026/0340652 A1
(43) Pub. Date: Oct. 29, 2026

(54) COMPLIANCE DATA PROVISIONING MANAGEMENT

(71) Applicant: Wells Fargo Bank, N.A., San Francisco, CA (US)

(72) Inventors: Govinda Rajulu Nelluri, Hyderabad (IN); Hari Prasada Raju Kunadharaju, Hyderabad (IN)

(21) Appl. No.: 19/191,502

(22) Filed: Apr. 28, 2025

(51) Int. Cl. G06Q 30/018; H04L 9/00; H04L 9/32

(52) U.S. Cl. CPC G06Q 30/018; H04L 9/008; H04L 9/3221

(57) ABSTRACT

Automated provisioning of compliance reports to regulators. Regulators can pull compliance reports that are generated in response to regulators' queries. The queries call one or more data funnels that determine from which data streets and data colonies the compliance data is pulled for generating the compliance reports. A distributed ledger, homomorphic encryption, zero knowledge application program interfaces and zero knowledge proofs can be used to enhance security of the compliance report generation and provisioning processes.

### RELATED APPLICATION

This patent application is related to U.S. patent application Ser. No. 18/644,710 filed Apr. 24, 2024, the content of which is hereby incorporated by reference in its entirety.

### BACKGROUND

Regulatory compliance in the transactional financial market is becoming increasingly complex and dynamic due to geopolitical and other requirements. Regulators commonly demand reports from financial enterprises demonstrating compliance with ever-evolving regulations. Due to regulatory requirements, the data needed to prepare such reports is stored in an progressively segmented and geographically dispersed manner.

### SUMMARY

Examples provided herein are directed to managing provisioning of compliance data for regulatory bodies.

According to one aspect, a method for provisioning a compliance report includes: receiving, by a server device, a query from a regulator device, the query including a call to at least one data funnel, the query being received via a zero trust application programming interface; verifying, by the server device, a regulator associated with the query; in response to the verifying, determining, by the server device using a zero knowledge proof, that compliance data responsive to the query is stored in a data street of a data colony, the data street or the data colony being defined by the at least one data funnel; in response to the determining, generating, by the server device, the compliance report based on the compliance data and the at least one data funnel, the compliance report being encrypted; and sending, by the server device, the compliance report to the regulator device.

According to another aspect, a system for provisioning a compliance report includes: a server device; a regulator device; a plurality of data streets stored in a plurality of data colonies; a distributed ledger; processors; and memory encoding instructions which, when executed by the processors, cause the processors to: send, by the server device, a query, the query including a call to at least one data funnel, the query being sent to the server device via a zero trust application programming interface; verify, by the server device, a regulator associated with the query based on a decentralized identity token associated with the regulator device and stored on the distributed ledger; in response to the verify, determine, by the server device using a zero knowledge proof, that homomorphically encrypted compliance data responsive to the query is stored in a data street of a data colony, the data street or the data colony being defined by the at least one data funnel; in response to the determine, generate, by the server device, the compliance report based on the homomorphically encrypted compliance data and the at least one data funnel, the compliance report being generated with encrypted data and without decrypting the homomorphically encrypted compliance data; send, by the server device, the compliance report to the regulator device; decrypt, by the regulator device, the compliance report; and store information associated with the compliance report on the distributed ledger.

According to another aspect, a method for provisioning a compliance report includes: encrypting compliance data stored in a data street of a data colony using homomorphic encryption to provide homomorphically encrypted compliance data; receiving, by a server device, a query from a regulator device, the query including a call to data funnels, the query being received via a zero trust application programming interface; verifying, by the server device, a regulator associated with the query, the verifying being performed using a decentralized identity token associated with the regulator device and based on a contract stored on a distributed ledger; modifying, by the server device, a sequence of the data funnels based on the query to provide a modified sequence of the data funnels; in response to the verifying, determining, by the server device using a zero knowledge proof, that the homomorphically encrypted compliance data includes data responsive to the query stored in the data street of the data colony, the data street and the data colony being defined by the data funnels; in response to the determining, applying, by the server device, the data funnels in the modified sequence to generate the compliance report based on the homomorphically encrypted compliance data, the compliance report being encrypted, the generating being performed without decrypting the homomorphically encrypted compliance data; sending, by the server device, the compliance report to the regulator device; and storing information associated with generation of the compliance report on the distributed ledger.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for managing provisioning of compliance data.

FIG. 2 shows example logical components of a server device of the system of FIG. 1.

FIG. 3 shows additional details of the system of FIG. 1.

FIG. 4 shows a method that can be performed by the system of FIG. 1.

FIG. 5 shows example physical components of a portion of the system of FIG. 1.

### DETAILED DESCRIPTION

This disclosure relates to secure and efficient provisioning of compliance data for regulatory bodies.

In current transaction banking (payments, trade finance, cards, markets), a localization trend demanding certain data to be stored in certain geographic areas is gaining popularity because of geo-political issues. Financial institutions operate across multiple jurisdictions, each with its own data residency laws requiring that financial data be stored and processed within specific geographical boundaries. When regulators demand access to transactional data to ensure compliance, financial institutions expend vast resources to provision the requested data. The high cost is due in part to the increase in segmentation of data storage across jurisdictions.

Provisioning compliance data to regulatory bodies can present several challenges. For example, different jurisdictions impose their own different and strict rules governing financial data storage and processing. Financial institutions often struggle to manage jurisdictional requirements while maintaining a unified data ecosystem. Regulatory bodies require access to transaction data for auditing, fraud detection, and compliance verification. However, direct access to financial institution databases raises privacy concerns and risks and the possibility if unauthorized exposure of sensitive customer data and/or proprietary institutional data.

Data breaches, unauthorized access, and lack of up-to-date compliance monitoring expose financial institutions to heavy fines and reputational damage. To reduce some of these pitfalls, financial institutions expend significant resources and manpower to manually prepare compliance reports specifically tailored to individual regulating bodies' demands, often with painstaking effort to ensure the reports are neither overinclusive of data nor underinclusive of data and strictly adhere to confidentiality requirements.

The present disclosure can advantageously alleviate one or more of these challenges. For example, the present disclosure provides for automated provisioning of compliance reports to regulators. Regulators can pull compliance reports that are generated in response to regulators' queries. The queries call one or more data funnels that determine from which data streets and data colonies the compliance data is pulled for generating the compliance reports. A distributed ledger, homomorphic encryption, zero knowledge application program interfaces and zero knowledge proofs can be used to enhance security of the compliance report generation and provisioning processes.

Each of these aspects individually and/or in combination can provide various advantages associated with the technologies described herein. For instance, using the technologies described herein, regulatory bodies are able to pull their compliance reports with minimal or no involvement from the financial institution managing the underlying instructions. The reports are generated securely and without exposure to the regulatory agency of unneeded data or data that compromises underlying customers' privacy or institutional proprietary data. In addition, the regulatory bodies requesting the compliance reports are verified and the existence of the data responsive to the regulatory bodies' queries is verified without decrypting or otherwise revealing the underlying data, which may be sensitive and/or private data. Many other advantages are applicable based upon the technologies discussed herein.

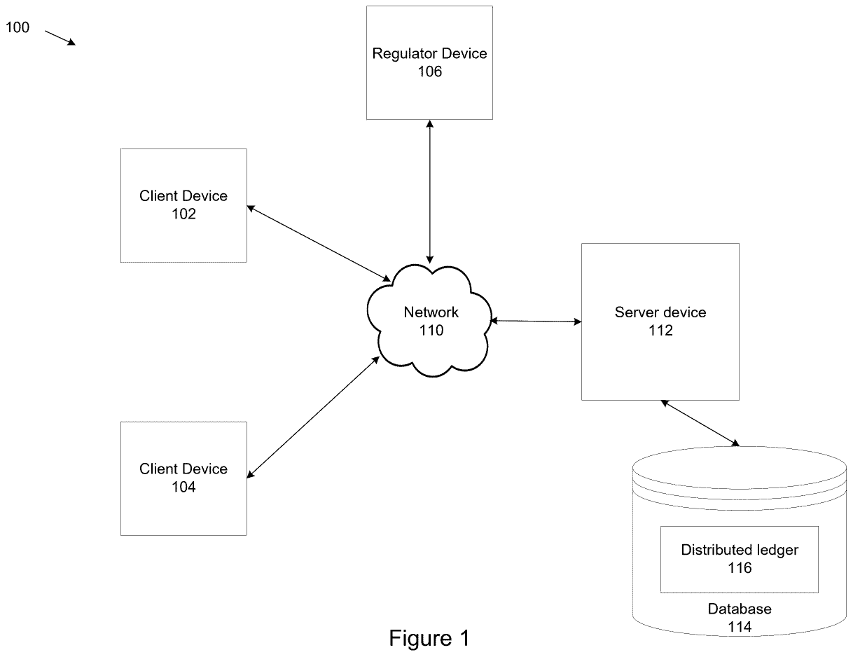

FIG. 1 shows an example system 100 for managing provisioning of compliance data. In this example, the system 100 can be a computing environment that includes a plurality of client and server devices. In this instance, the system 100 includes client devices 102, 104, a server device 112, a database 114, and regulator device 106. The client devices 102, 104 and the regulator device 106 can communicate with the server device 112 through a network 110 to accomplish functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client devices 102, 104 can be programmed to communicate with the server device 112 to accomplish financial transactions. The regulator device 106 can be programmed to communicate with the server device 112 to pull compliance data stored on a distributed ledger 116.

In FIG. 1, the distributed ledger 116 is depicted as a component of the database 114. The database 114 can be include many data storage locations and other computing devices located in different jurisdictions in order to provide the functionality of the distributed ledger 116. Many other configurations are possible.

The example client devices 102, 104 are programmed to facilitate financial transactions. In one example, the client device 102 is the originator (payor) for a transaction. The client device 104 is the beneficiary (payee) for the transaction. Various mechanisms can be used to accommodate the transaction. Such mechanisms can include, without limitation: card transactions (e.g., credit/debit card payments); wire transfers; Automated Clearing House (ACH) payments; and/or application payments (e.g., Zelle, Venmo, WhatsApp).

The example server device 112 is programmed to facilitate the transaction between the client devices 102, 104. The server device 112 is programmed to colonize transactional data associated with the transaction between the client devices 102, 104. This colonization can be performed based upon various aspects associated with the transaction, such as geographic considerations related to the location of the client device 102 and/or the client device 104. Many configurations are possible.

The example server device 112 is also programmed to facilitate management of compliance data such that compliance data is provisioned to the regulator bodies associated with regulator devices, such as the regulator device 106. As will be described in more detail below, the regulator device 106 sends a query requesting certain compliance data that is received and processed by the server device 112. The server device 112 processes the regulator's query, allowing automated generation of an encrypted compliance report that is responsive to the query and provided back to the regulator device 106.

Depending on applicable rules, the regulator device 106 can send a query requesting compliance data according to any frequency (e.g., once a day, once a week, once a month), or randomly. The regulator body associated with the regulator device 106 seeks compliance data to ensure that the transactions handled by the server device 112 from client devices (such as client devices 102 and 104) comply the regulator body's regulations that apply to those transactions.

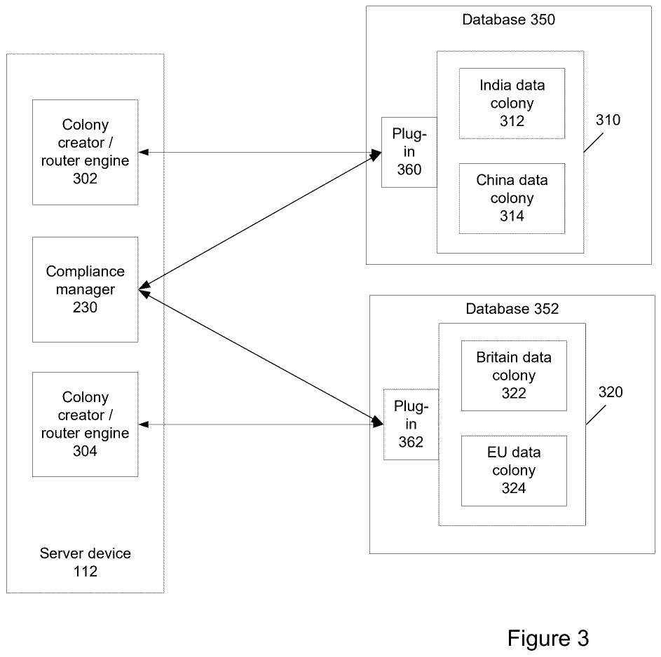

The example database 114 is programmed to store data associated with the transactions processed by the server device 112. In some examples, this data can include the aspects associated with the transaction. In the examples provided below, the database 114 can be broken into multiple databases, such as a distributed ledger 116, and/or otherwise distributed geographically to address the colonization requirements for the system 100. See, e.g., FIG. 3.

The network 110 provides a wired and/or wireless connection between the client devices 102, 104, the regulator device 106, and the server device 112. In some examples, the network 110 can be a local area network, a wide area network, the Internet, or a mixture thereof. Many different communication protocols can be used. Although only four devices are shown, the system 100 can accommodate hundreds, thousands, or more of computing devices. For example, the system 100 can include many different regulator devices associated with many different regulators that have a stake in the transactions processed by the server device 112.

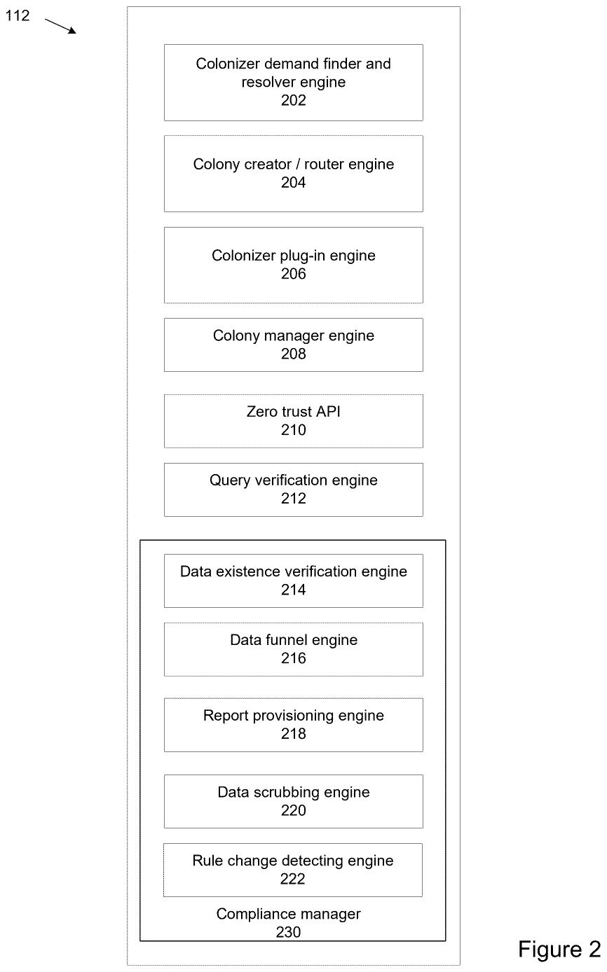

Referring now to FIGS. 2 and 3, additional details of the system 100, including the server device 112, are shown. In this example, the server device 112 has various logical modules that assist in the colonization of the transactional data and provisioning of compliance data. The server device 112 can, in this instance, include a colonizer demand finder and resolver engine 202, at least one colony creator/router engine 204, a colonizer plug-in engine 206, and a colony manager engine 208. The server device 112 also includes a compliance manager 230 with various different engines described below, a zero trust application programming interface (API) 210 and a query verification engine 212. In other examples, more or fewer engines providing different functionality can be used.

The example colonizer demand finder and resolver engine 202 is programmed to identify and create data colonies based upon demand. For instance, in this example, the colonizer demand finder and resolver engine 202 is programmed to receive aspects associated with the transaction between the client device 102 and the client device 104. These aspects can include transactional data such as originator location, beneficiary location, etc. Based upon this transactional data, the colonizer demand finder and resolver engine 202 can determine which colony is on correct land to address originator localization requirements.

In one example, the transactional data associated with the transaction can include a context packet having such information as:
location of originator—location of the originator of the transaction (e.g., the client device 102);
location of the beneficiary—location of the beneficiary of the transaction (e.g., the client device 104);
payment type—the type of payment, such as card, ACH, wire, application, etc. ;
point of sale—a geotagged location for the actual point of sale for the transaction (which can differ from the locations of the client devices 102, 104);
type of transaction—the type of transaction, such as real-time or batch;
type of payment—the type of payment, such as regular or high value; and/or on-us or off-us transaction—whether the transaction is handled by a single institution or is between institutions.

Based upon the context packet for the transaction, the colonizer demand finder and resolver engine 202 uses one or more models to determine whether a colony exists to store the transaction. The colonizer demand finder and resolver engine 202 thereupon communicates the transaction and instructions on whether to route the transaction to an existing colony and/or create a new colony to the colony creator/router engine 204.

The example colony creator/router engine 204 is programmed to route transactions to appropriate colonies based upon input from the colonizer demand finder and resolver engine 202. More specifically, the colony creator/router engine 204 monitors the demand for colonies of data for the system 100, creates and/or destroys colonies as necessary, and routes transactions to the appropriate colony.

For instance, for a transaction where there is an existing colony, the colony creator / router engine 204 is programmed to route the transaction to that appropriate colony. As illustrated in FIG. 3, the server device 112 can include multiple colony creator/router engines 302, 304 that handle different colonies for the system 100.

When the colonizer demand finder and resolver engine 202 determines that an existing colony is appropriate for a transaction having a particular context, the colony creator/router engines 302, 304 can route the transaction to the appropriate colony. In the example provided, assume the originator is located in India. The context packet indicates the origination in India, and the colonizer demand finder and resolver engine 202 routes the transaction to the colony creator/router engine 302.

The colony creator/router engines 302, 304, in turn, route the transaction to the appropriate colony within the database 114 associated with the system 100. In some examples, the database 114 can be broken or otherwise distributed across a geographic area or areas, such as the databases 350, 352 provided in FIG. 3. In the example, the databases 350, 352 are located in different geographic regions and provide different colonies, as described further below. In some examples, the databases 350, 352 are two of many devices that support the distributed ledger 116. The colony creator/router engines 302, 304 communicate with the colonizer plug-in engine 206 described below to store the data associated with the transaction in the appropriate colony.

In addition, the compliance manager 230 communicates with the databases, colonies and streets to facilitated provisioning of compliance data in response to regulator queries.

Should the appropriate colony not exist on one or more of the databases 350, 352, the colony creator/router engines 302, 304 can be programmed to create the required new colony. This can include such aspects as: (i) identifying a proper geographic location for the new colony; (ii) identifying different transaction types to be stored within different data streets within a colony, which are segmented storage areas for different types of transactions within a colony.

Further, the colony creator/router engine 204 can be programmed to destruct one or more colonies should the regulatory environment change. For instance, a country may change its regulatory requirements such that transaction data is no longer required to be stored locally within a country. Upon such a regulatory change, the colony creator/router engine 204 is programmed to modify the colonies on the databases 350, 352 appropriately. For instance, the colony creator/router engine 204 may combine colonies so that data associated with transactions for that country are stored with other countries in a location that is more efficient and/or cheaper for processing and storage of transactions. This deprovisioning of a colony can result in significant advantages in efficiency and cost.

The example colonizer plug-in engine 206 is programmed to provide an interface between the colony creator/router engines 302, 304 and the compliance manager 230 on the one hand, and data colonies 310, 314, 322, 324 stored on the databases 350, 352. More specifically, a plug-in 360, 362 is provided for each colony 310, 320. The respective plug-in 360, 362 identifies the contextualized transactions and puts them in respective schemas/documents/tables within the respective colony 310, 320.

Each plug-in 360, 362 can be programmed to communicate with the databases 350, 352 according to the specific technology used. Examples of such technologies include Oracle, MongoDB, Database 2 (DB2), Google, and Amazon Web Services (AWS). For instance, the plug-in 360, 362 can be agnostic with respect to the type of transaction and the context packet associated therewith. The plug-in 360, 362 can identify the schema used for the context packet and the technology used by the database 350, 352 for storage of the colony 310, 320.

Further, the plug-in 360, 362 can be programmed to identify where within which colony 310, 320 the transaction should be stored. For instance, in this example, the colony 310 includes an India data colony 312 and a China data colony 314. Similarly, the colony 320 includes a Britain data colony 322 and an EU data colony 324. Each of these colonies 312, 314, 322, 324 is configured to satisfy certain regulatory requirements for a particular geography.

For instance, assume that the transaction described above includes the client device 102 (as originator) located in India. In this example, based upon the location of origination, the transaction is routed by the colony creator/router engine 302 to the plug-in 360. The plug-in 360, in turn, translates the data associated with the transaction for storage in the India data colony 312 within the database 350. The India data colony 312 is configured to satisfy India regulatory requirements for such transaction, such as storing the data within India for a particular period of time (e.g., 5 years).

In some examples, the plug-in 360 is further programmed to store the data within a specific data street within the India data colony 312. For instance, assume the example transaction is a card transaction between the client devices 102, 104. The plug-in 360 is programmed to store the data associated with the transaction within a data street associated with card transactions within the India data colony 312. Multiple data streets can be provided within a colony, such as being segmented by transaction type and/or divided or combined based upon data size, etc.

In these examples, the plug-ins 360, 362 can user various classification processes for selecting the appropriate database, colony, and data street for storage of transactional data. These classifications can be based upon the schema associated with the context packet for each transaction. The plug-ins 360, 362 can use comparative analytic models and libraries for classification to select the appropriate data street. Many configurations are possible.

The example colony manager engine 208 is programmed to manage the various components of the system 100. For instance, the colony manager engine 208 can crawl the various data colonies 310, 320 for the system 100 to orchestrate changes to accommodate regulations and/or increase efficiency.

For instance, the colony manager engine 208 can determine when a particular colony is too large and thereby divide the colony into smaller pieces. For instance, the colony manager engine 208 can determine how many data streets are associated with a colony and increase those data streets as necessary to accommodate increases in data while maintaining efficiency for the databases 350, 352.

Further, the colony manager engine 208 can be programmed to accommodate changes in the number of colonies and/or financial institutes associated with the colonies. For example, the colony manager engine 208 can be programmed to add a financial institution to one or more colonies to allow the new financial institution to participate in the advantages associated with the system 100. The colony manager engine 208 can segregate such data so that transactions for additional financial institutions can be added or removed from the system 100 as desired.

The segmentation of transaction data amongst various data colonies and data streets as just described can lead to challenges in identifying relevant data to pull and where (e.g., which colonies and streets) that data is located to pull from in order to generate compliance reports in response to regulators' needs. Solutions to these challenges that can be performed by the system 100 will now be described with continued reference to FIGS. 1, 2 and 3.

The regulator device 106 sends a query requesting compliance data relating to one or more transactions stored in one or more data colonies and data streets, as described with reference to FIG. 3.

The request is routed to the server device 112 via the network 110 through the zero trust API 210. Every API request via the zero trust API 210, regardless of its origin, is authenticated, authorized, and validated before access to the server device 112 and data colonies is granted.

The query verification engine 212 processes the query received via the zero trust API 210 and determines if the query has been sent by a trusted regulator device. If the zero trust API verifies that the device that sent the query is a trusted regulator device, then the query is passed to the compliance manager 230.

The data existence verification engine 214 checks to see if transaction data responsive to the verified query actually exists. To do this check, the data existence verification engine 214 deploys a zero knowledge proof (ZKP) to any data streets and data colonies identified by the data funnel engine 216 as possibly containing compliance data that is responsive to the query. A ZKP is a cryptographic protocol where one party, in this case, a given data street or data colony, can convince another party, in this case, the data existence verification engine 214, that a statement is true, without revealing any information beyond the truth of that statement. This allows for verification of information without exposing the underlying data, thereby enhancing privacy and security of the underlying data to the extent it exists.

The data funnel engine 216 manages one or more data funnels for a given query. Data funnels are advantageous in that they help narrow down which data colonies and data streets may actually contain data relevant to a given compliance data query.

Examples of types of data funnels include a location data funnel, a compliance data funnel, and a domain data funnel. A location data funnel filters by location, pulling data only from data colonies or data streets in locations that are in a geography relevant to the query. A compliance data funnel filters by compliance type, such as sanctions compliance, anti-money laundering compliance, tax compliance, and the like, pulling data only from data colonies or data streets that store transaction data relevant to the compliance type of a given query. A domain data funnel filters by domain type, such as a payments domain, a trade domain, an investment domain, and the like, pulling data only from data colonies or data streets that store transaction data relevant to the domain type of a given query. Other types of data funnels are possible.

Each query will include a call to one or more funnels based on what compliance data is being sought by the regulator. For a given regulator query, one or more funnels may be applicable and applied by the data funnel engine 216.

The data funnel engine 216 can also adjust the sequence in which multiple data funnels are applied for a given query, thereby advantageously increasing efficiency for the system 100 by minimizing the number of data colonies and/or data/streets that are accessed in order to provide the requested compliance data.

For example, a first regulator body query may require all anti-trust compliance data regardless of where that compliance data is stored geographically, whereas a second regulator body query from a different regulator may require all anti-trust compliance data stored in India only. For the first query, the data funnel engine 216 will apply the compliance data funnel only so that only data streets or data colonies that contain transaction data related to anti-trust compliance are accessed for responding to the query. For the second query, however, the data funnel engine 216 will apply the location data funnel and the compliance data funnel in that sequence, so that only only data streets or data colonies located in India and that contain transaction data related to anti-trust are accessed for responding to the query.

The data funnel engine 216 includes logic that optimizes the sequence in which the different data funnels are applied for a given query to maximize efficiency and minimize the data streets or data colonies to which zero knowledge proofs are actually deployed. For instance, if a particular data street or data colony does not contain data relevant to a given query, the data funnel engine 216 ensures that the data street or data colony is not issued a zero knowledge proof in relation to the query, thereby saving time and computing resources.

Once the relevant data street(s) and/or data colony(ies) have been identified by the data funnel engine 216 and the data existence verification engine 214, the report provisioning engine 218 generates a compliance report based on the transaction data contained in the identified data street(s) and/or data colony(ies).

The data scrubbing engine 220 ensures that the only needed data is included in the report, and eliminates certain kinds of sensitive data, such as customer names, social security numbers, and other types of identification information. The data scrubbing engine 220 can scrub the data such that the compliance report includes only aggregated transaction data, anonymized transaction data, and/or transaction data with sensitive information masked, for example.

The scrubbed compliance report is then generated by the compliance manager 230 and sent to the regulator device 106.

To enhance security of the system 100 and the automated provisioning of compliance reports to regulators, the system 100 can be fortified with various cryptographic protocols. For example, the underlying transaction data stored in the data colonies and data streets and from which compliance reports are ultimately generated can be homomorphically encrypted in the data colonies and data streets. The report provisioning engine 218 can generate the report without decrypting the homomorphically encrypted compliance data that it contains. That is, the underlying transaction data, in some examples, is not decrypted to generate the compliance report. Only once the compliance report is received by the regulator device 106 can the regulator device 106 decrypt the compliance report in order to read the compliance data that has been pulled in response to the regulator's query.

In some examples, the decryption protocol used by the regulator device 106 is contained in a smart contract between the regulator body and the financial institution. For added, security, the smart contract can be stored on the distributed ledger 116. The regulator device 106 must consult the decryption protocol contained in the smart contract in order to decrypt the compliance report.

In some examples, the query verification engine 212 consults the smart contract on the distributed ledger 116 to verify that the entity sending the compliance data query is who it claims to be. For example, the smart contract may contain a communication key that must be used by the regulator device 106 when communicating with the server device 112. The query verification engine 212 looks up the communication key in the smart contract and determines if the query includes the communication key. If the query does include the communication key, then the query is legitimate and the regulator is verified. If the query does not include the communication key, then the regulator is not verified and no compliance report is generated.

Similarly, in some examples, each query can include a regulator unique or query unique decentralized identity token that is associated with the regulator device 106. In some examples, the identity token can be stored on the distributed ledger 116. The query verification engine 212 looks up the identity token if the query includes the identity token. If the query does include the identity token, then the query is legitimate and the regulator is verified. If the query does not include the identity token, then the regulator is not verified and no compliance report is generated.

The rule change detecting engine 222 determines changes in rules promulgated by regulator bodies. Such changes can require underlying transaction data used for compliance data to be stored in another data street or another data colony, for example, or for different types of transactional data to be provided in response to certain requests for compliance data. The rule change detecting engine 222 continuously scans and updates storage locations based on new regulatory changes it detects via artificial intelligence-driven monitoring of, e.g., legal databases. The rule change detecting engine 222 can also capture changes in transaction patterns that require adjustments in storage and changes in banking entity requirements that may shift due to operational changes.

If a data residency rule changes, for example, impacted data is automatically migrated to a compliant data street or data colony with minimal disruption. In some examples, the old data street or data colony is then automatically destroyed, as described above.

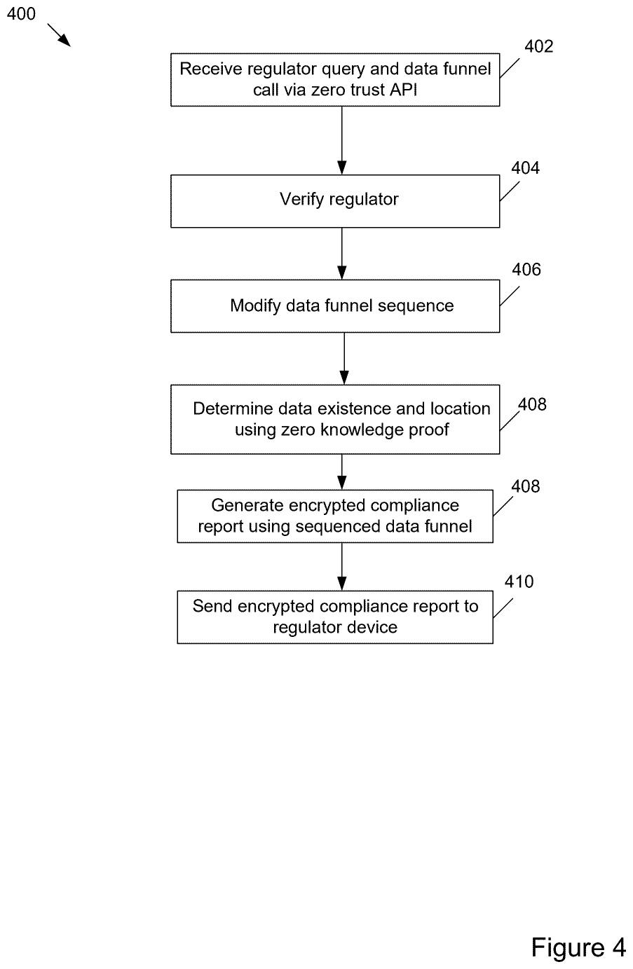

FIG. 4 shows a method 400 that can be performed by the system of FIG. 1. Methods consistent with this disclosure need not include all of the illustrated steps of the method 400. Methods consistent with this disclosure need not be performed in the illustrated order of steps of the method 400. Methods consistent with this disclosure may include additional steps not illustrated in FIG. 4. In some examples, the steps of the method 400 are performed by the server device 112.

At a step 402 of the method 400, a regulator query is received via a zero trust API. The query includes a call to one or more data funnels.

At a step 404 of the method 400, the regulator is verified based on information provided with, or contained within, the query, such as a decentralized identity token.

At a step 406 of the method 400, a sequence of application of data funnels is modified based on the query.

At a step 408 of the method 400, it is determined whether data responsive to the query exists using a ZKP. Application of the modified sequence of funnels facilitates identifying of candidate locations for the data.

At a step 410 of the method 400, an encrypted compliance report generated based on the data identified at the step 408 is generated and sent to the regulator device.

### Computing Architecture

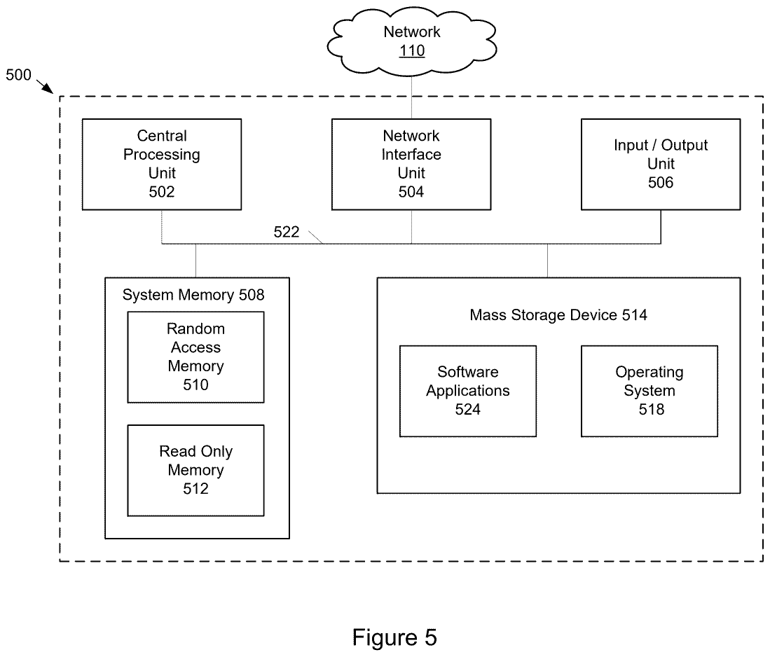

Additional components of the system 100 of FIG. 1 are illustrated in FIG. 5.

The electronic computing device 500 can correspond to any of the server device 112, the client device 102, the client device 104, and the regulator device 106 of the system 100 of FIG. 1. Components of the computing device 500 can correspond to other components of the system 100 of FIG. 1, such as the database(s) 114.

When the computing device 500 corresponds to the server device 112, the computing device 500 can be an internally controlled and managed device (or multiple devices) of an enterprise, such as a financial institution. Alternatively, the computing device 500 can represent one or more devices operating in a shared computing system external to the enterprise, such as a cloud.

As illustrated in the embodiment of FIG. 5, the example computing device 500, which provides the functionality described herein, can include at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system containing the basic routines that help transfer information between elements within the computing device 500, such as during startup, is stored in the ROM 512. The computing device 500 further includes a mass storage device 514. The mass storage device 514 can store software instructions and data such as the various modules and engines depicted in FIGS. 1 and 2. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the computing device 500. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 500.

According to various embodiments of the invention, the computing device 500 may operate in a networked environment using logical connections to remote network devices through network 110, such as a wireless network, the Internet, an NFC network, or another type of network, or combination of networks. The computing device 500 may connect to a network 110 through a network interface unit 504 connected to the system bus 522. It should be appreciated that the network interface unit 504 may also be utilized to connect to other types of networks and remote computing systems. The computing device 500 also includes an input/output controller 506 for receiving and processing input from a number of other devices, including a touch user interface display screen or another type of input device, such as a microphone a, keyboard, a mouse, and the like. Similarly, the input/output controller 506 may provide output to a touch user interface display screen or other output devices, such as a speaker, a haptic generator (e.g., a vibrating structure), or the like.

As mentioned briefly above, the mass storage device 514 and the RAM 510 of the computing device 500 can store software instructions and data. The software instructions include an operating system 518 suitable for controlling the operation of the computing devices of the system 100. The mass storage device 514 and/or the RAM 510 also store software instructions and applications 524, that when executed by the CPU 502, cause the computing device 500 to provide the functionality of the various devices of the system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for provisioning a compliance report, comprising:
receiving, by a server device, a query from a regulator device, the query including a call to at least one data funnel, the query being received via a zero trust application programming interface;
verifying, by the server device, a regulator associated with the query;
modifying. by the server device, a sequence in which the at least one data funnel is applied based on the query to minimize a number of data streets and data colonies to which the server device deploys a zero knowledge proof;
in response to the verifying, determining, by the server device using the zero knowledge proof deployed to the data streets and data colonies according to the modified sequence of the at least one data funnel, that homomorphically encrypted compliance data responsive to the query is stored in a data street of a data colony, the data street or the data colony being defined by the at least one data funnel;
in response to the determining, generating, by the server device, the compliance report based on the homomorphically encrypted compliance data and the at least one data funnel, the compliance report being encrypted, wherein the generating is performed without decrypting the homomorphically encrypted compliance data; and
sending, by the server device, the compliance report to the regulator device.

2. The method of claim 1,
wherein the at least one data funnel includes at least two data funnels;
wherein the method further comprises modifying, by the server device, a sequence in which the at least two data funnels are applied by the server device to the compliance data based on the query.

3. The method of claim 2, further comprising:
applying, by the server device, the at least two data funnels to the compliance data to select a subset of the compliance data for inclusion in the compliance report.

4. The method of claim 1, further comprising:
scrubbing, by the server device, data contained in the compliance report, the scrubbing including at least one of aggregating the data, anonymizing the data, and masking the data.

5. (canceled)

6. The method of claim 1, further comprising prior to the generating, encrypting compliance data using homomorphic encryption to generate the homomorphically encrypted compliance data.

7. The method of claim 1, further comprising:
determining, by the server device, a change in a rule, the change requiring the compliance data to be stored in another data street; and
moving, by the server device, the compliance data to the another data street.

8. The method of claim 7, further comprising destroying, by the server device, the data street.

9. The method of claim 7, wherein the another data street is located in another data colony.

10. The method of claim 1, wherein the verifying is performed using a decentralized identity token associated with the regulator device.

11. The method of claim 1, wherein the verifying is performed based on a contract stored on a distributed ledger.

12. The method of claim 1, further comprising storing information associated with generation of the compliance report on a distributed ledger.

13. A system for provisioning a compliance report, comprising:
a server device;
a regulator device;
a plurality of data streets stored in a plurality of data colonies;
a distributed ledger;
processors; and
memory encoding instructions which, when executed by the processors, cause the processors to:
send, by the server device, a query, the query including a call to at least one data funnel, the query being sent to the server device via a zero trust application programming interface;
verify, by the server device, a regulator associated with the query based on a decentralized identity token associated with the regulator device and stored on the distributed ledger;
modify, by the server device, a sequence in which the at least one data funnel is applied based on the query to minimize a number of data streets and data colonies to which the server device deploys a zero knowledge proof;
in response to the verify, determine, by the server device using the zero knowledge proof deployed to the data streets and data colonies according to the modified sequence of the at least one data funnel, that homomorphically encrypted compliance data responsive to the query is stored in a data street of a data colony, the data street or the data colony being defined by the at least one data funnel;
in response to the determine, generate, by the server device, the compliance report based on the homomorphically encrypted compliance data and the at least one data funnel, the compliance report being generated with encrypted data and without decrypting the homomorphically encrypted compliance data;
send, by the server device, the compliance report to the regulator device;
decrypt, by the regulator device, the compliance report; and
store information associated with the compliance report on the distributed ledger.

14. The system of claim 13,
wherein the at least one data funnel includes at least two data funnels; and
wherein the memory encodes further instructions which, when executed by at least one of the processors, cause the at least one of the processors to:
modify, by the server device, a sequence in which the at least two data funnels are applied by the server device to the homomorphically encrypted compliance data based on the query.

15. The system of claim 14,
wherein the memory encodes further instructions which, when executed by the at least one of the processors, cause the at least one of the processors to:
apply, by the server device, the at least two data funnels to the homomorphically encrypted compliance data to select a subset of the homomorphically encrypted compliance data for inclusion in the compliance report.

16. The system of claim 13,
wherein the memory encodes further instructions which, when executed by the at least one of the processors, cause the at least one of the processors to:
scrub, by the server device, data contained in the compliance report by at least one of aggregating the data, anonymizing the data, and masking the data.

17. The system of claim 13,
wherein the memory encodes further instructions which, when executed by the at least one of the processors, cause the at least one of the processors to:
determine, by the server device, a change in a rule, the change requiring the homomorphically encrypted compliance data to be stored in another data street; and
move, by the server device, the homomorphically encrypted compliance data to the another data street.

18. The system of claim 17,
wherein the memory encodes further instructions which, when executed by the at least one of the processors, cause the at least one of the processors to:
further destroy, by the server device, the data street.

19. The system of claim 17, wherein the another data street is located in another data colony.

20. A method for provisioning a compliance report, comprising:
encrypting compliance data stored in a data street of a data colony using homomorphic encryption to provide homomorphically encrypted compliance data;
receiving, by a server device, a query from a regulator device, the query including a call to data funnels, the query being received via a zero trust application programming interface;
verifying, by the server device, a regulator associated with the query, the verifying being performed using a decentralized identity token associated with the regulator device and based on a contract stored on a distributed ledger;
modifying, by the server device, a sequence in which the data funnels are applied based on the query to provide a modified sequence of the data funnels and to minimize a number of data streets and data colonies to which the server device deploys a zero knowledge proof;
in response to the verifying, determining, by the server device using the zero knowledge proof deployed to the data streets and data colonies according to the modified sequence of the data funnels, that the homomorphically encrypted compliance data includes data responsive to the query stored in the data street of the data colony, the data street and the data colony being defined by the data funnels;
in response to the determining, applying, by the server device, the data funnels in the modified sequence to generate the compliance report based on the homomorphically encrypted compliance data, the compliance report being encrypted, the generating being performed without decrypting the homomorphically encrypted compliance data;
sending, by the server device, the compliance report to the regulator device; and
storing information associated with generation of the compliance report on the distributed ledger.
